(19) United States
(12) Patent Application Publication
(10) Pub. No.: US 2005/0029030 A1
(43) Pub. Date: Feb. 10, 2005

(54) Remote/radio controlled, self-propelled utility cart

(76) Inventor: Daniel Ewert, Shakopee, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/655,566

(22) Filed: Sep. 4, 2003

Related U.S. Application Data
(60) Provisional application No. 60/408,449, filed on Sep. 5, 2002.
(60) Provisional application No. 60/423,942, filed on Nov. 5, 2002.

(51) Int. Cl. B62D 1/24

(52) U.S. Cl. 180/167

(57) ABSTRACT

A self-propelled, remote-controlled utility cart of the present invention overcomes the disadvantages of present utility cart designs. Through the combination of a utility cart with a drive mechanism and a steering mechanism, the utility cart of the present invention can be used in circumstances in which typical, manual manipulation of the utility car is difficult if not impossible for the average homeowner. In one embodiment, the self-propelled, remote-controlled utility cart takes the form of an ice chest. The combination of an insulated cooler design with a drive mechanism and steering mechanism such that the ice cooler is self-propelled effectively eliminates any hand-carrying requirements which is especially advantageous when the insulated cooler is fully loaded with food and beverages. The utility cart of the present invention further includes a control assembly allowing for remote operation of the drive and steering mechanisms by the user.

### RELATED APPLICATIONS AND PRIORITY CLAIM

The present invention claims priority to U.S. Provisional Application No. 60/408,449 entitled, “REMOTE/RADIO CONTROLLED, SELF-PROPELLED ICE CHEST,” filed Sep. 5, 2002, and U.S. Provisional Application No. 60/423,942 entitled, “REMOTE/RADIO CONTROLLED, SELF-PROPELLED ICE CHEST,” filed Nov. 5, 2002, both of which are hereby incorporated by reference in their entirety.

### FIELD OF THE INVENTION

The present invention relates generally to the field of portable utility carts such as portable ice coolers. More specifically, the present invention relates to a steerable, self-propelled utility cart for home use including a control apparatus for remote operation and direction of the utility cart's drive and steering mechanism.

### BACKGROUND OF THE INVENTION

Homeowners have many options when it comes to the use of utility carts for residential improvement projects or for miscellaneous odd jobs around the house. Utility carts can be used to transport dirt, sod, landscaping bricks or firewood. Another popular use is in transporting or holding items, such as food or beverages, necessary for entertaining guests.

Regardless of the use, most utility cart designs include some form of handle assembly allowing the user to manually direct the utility cart from one location to the next. Depending on the type of function the utility cart is performing, the load will often be heavy requiring a great deal of exertion on the part of the user. In some cases, the weight of the load may exceed the strength of the user such that manual transport of the utility cart is effectively impossible. An example of such a situation is when the utility cart takes the form of a portable ice chest and is filled with items such as ice, food and beverages.

Portable ice chests or “coolers” are well known by consumers and are frequently used in a wide variety of recreational settings such as camping, sporting events or for spare storage when a household freezer or refrigerator is full. Examples of typical ice chests or coolers include those manufactured by The Coleman® Company (http://www.coleman.com) and the Igloo® Products Corp. (http://www.igloocoolers.com). These coolers can range from small, hand carriable units for soft-drinks all the way to large, wheel borne coolers for transporting large amounts of food or beverages or even for storing freshly caught fish.

In use, a user will most typically place the food or beverage items which they desire to keep cold within the insulated interior of the ice chest. A cooling means such as ice cubes, ice blocks or refreezable, artificial ice packs are also placed within the interior of the ice chest and the cover is then closed. The combination of the cooling means with the insulated interior keeps the beverages or food items in a cooled state.

While current cooler designs are meant to be easily transportable, often the amount of food and beverages within the cooler makes them unwieldy and difficult, if not impossible, for a single user to carry. As such, it would be desirable to have a cooler that provides an individual user with the ability to more easily transport a cooler that is heavily laden with food and beverages.

### SUMMARY OF THE INVENTION

The self-propelled, remote-controlled utility cart of the present invention overcomes the disadvantages of present utility cart designs. Through the combination of a utility cart with a drive mechanism and a steering mechanism, the utility cart of the present invention can be used in circumstances in which typical, manual manipulation of the utility car is difficult if not impossible for the average homeowner.

With specific reference to an embodiment of a utility cart taking the form of an ice chest, the combination of an insulated cooler design with a drive mechanism and steering mechanism such that the ice cooler is self-propelled effectively eliminates any hand-carrying requirements which is especially advantageous when the insulated cooler is fully loaded with food and beverages. The utility cart of the present invention further includes a control assembly allowing for remote operation of the drive and steering mechanisms by the user.

### BRIEF DESCRIPTION OF THE DRAWINGS

FIG. 1 is an embodiment of a self-propelled, remote-controlled utility cart of the present invention.

FIG. 2 is a perspective view of a self-propelled, remote-controlled ice chest assembly of the present invention.

FIG. 3 is a perspective view of an ice chest of the present invention in an open disposition.

FIG. 4 is a sectional view of the ice chest of FIG. 2.

FIG. 5 is a top view of the ice chest of FIG. 2 in an open disposition.

FIG. 6 is a top view of the ice chest of FIG. 2 in an open disposition.

FIG. 7 is a bottom view of a steering mechanism.

FIG. 8 is a bottom, perspective view of a wheel assembly.

FIG. 9 is a bottom, perspective view of a drive mechanism.

FIG. 10 is a side view of a control instrument.

FIG. 11 is an embodiment of a self-propelled, remote-controlled ice chest assembly of the present invention.

FIG. 12 is a flow chart depicting a control method for the remote-controlled ice chest assembly of the present invention.

### DETAILED DESCRIPTION OF THE PREFERRED EMBODIMENTS

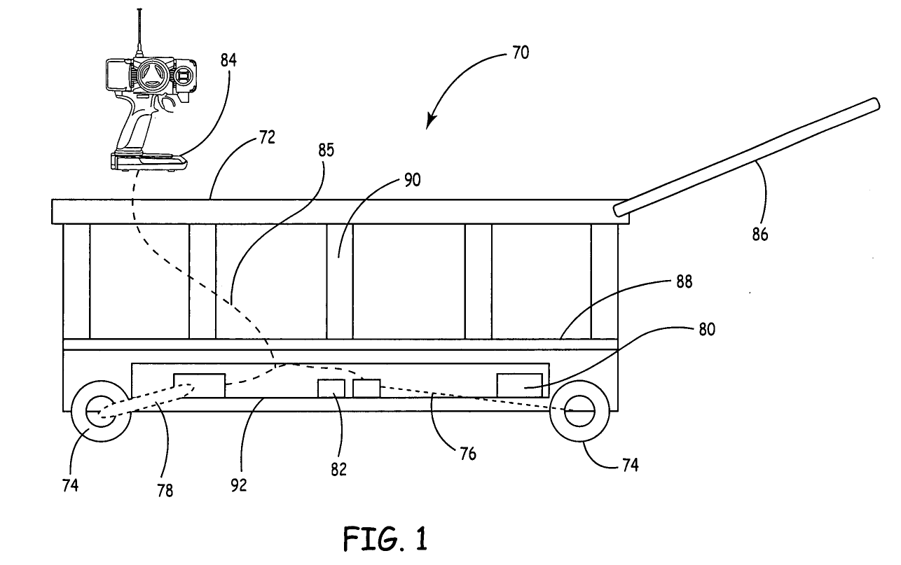

A self-propelled, remote-controlled utility cart 70 of the present invention is depicted in FIG. 1. Generally, utility cart 70 comprises a body 72 having a plurality of wheels 74, a steering mechanism 76, a drive mechanism 78, a power supply 80, a receiver 82 and a control device 84. Control device 84 may be directly wired to steering mechanism 76 and drive mechanism 78 with a length of control wire 85. Alternatively, control device 84 can utilize a wireless protocol, such as radio frequency or infrared, to communicate with the receiver. Utility cart 70 can also comprise a manual handle 86 to allow for manual direction of the utility cart 70. Typically, body 72 includes a loading floor 88 and may comprise side walls 90. Below loading floor 88 is a mounting floor 92 for mounting components associated with steering mechanism 76, drive mechanism 78, power supply 80 and receiver 82.

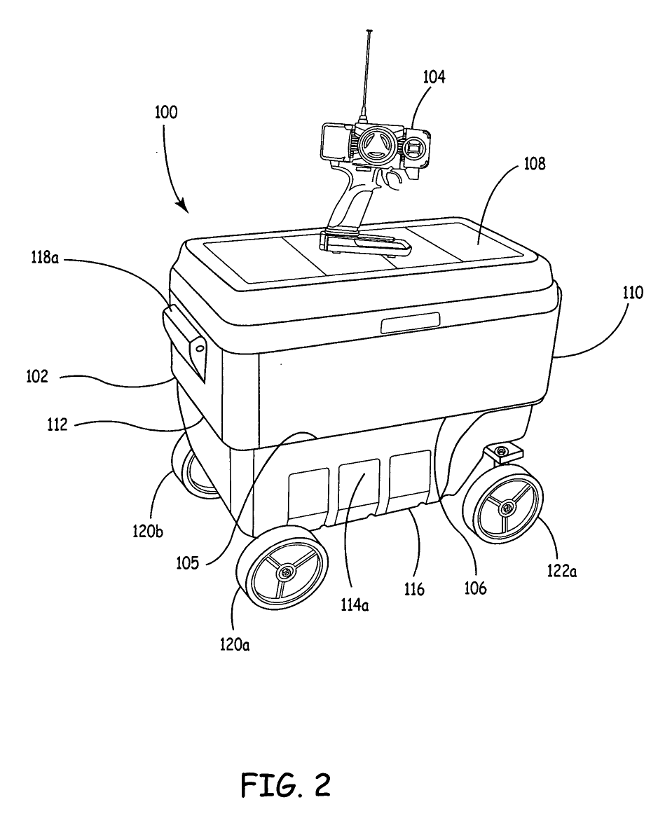

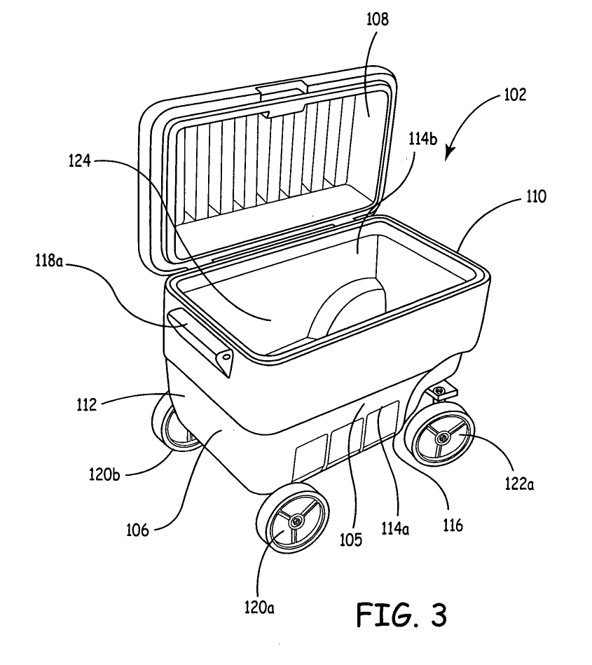

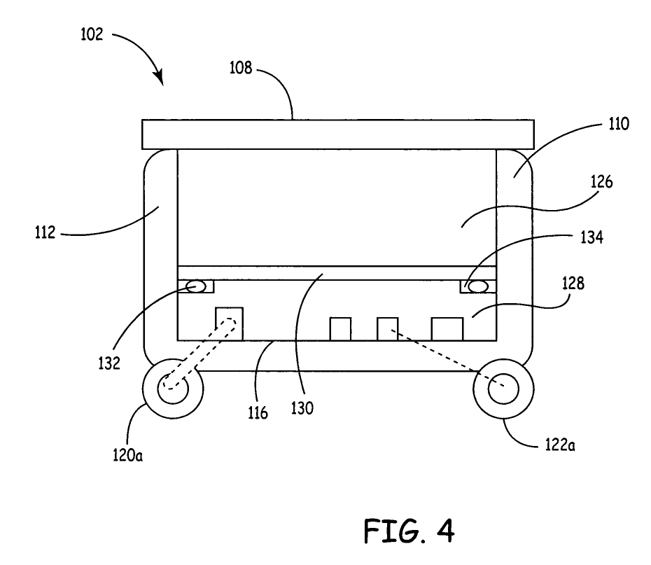

As depicted in FIG. 2, an embodiment of a self-propelled, remote-controlled utility cart 100 of the present invention comprises an ice chest assembly 102 and a wireless control device 104. Ice chest assembly 102 comprises an ice chest 105 having an insulated body 106 and an insulated cover 108. Insulated body 106 defines a front wall 110, a rear wall 112, a pair of side walls 114a, 114b and a bottom surface 116. To facilitate lifting of the ice chest assembly 102, a pair of handles 118a, 118b can be located on the front wall 110 and rear wall 112. Ice chest assembly 102 also includes a pair of drive wheels 120a, 120b and a pair of steering wheels 122a, 122b. Ice chest assembly 102 is further depicted in an open disposition in FIG. 3. An interior storage space 124 is defined by front wall 110, rear wall 112, side walls 114a, 114b, bottom surface 116 and insulated cover 108. As shown in FIG. 4, interior storage space 124 is divided into a refrigerated space 126 and a component mounting space 128 by an insulated sealing floor 130. Sealing floor 130 interacts with a perimeter seal 132 and a perimeter bracket 134 to prevent leakage, most typically water from melted ice, from the refrigerated space 126 into the component mounting space 128.

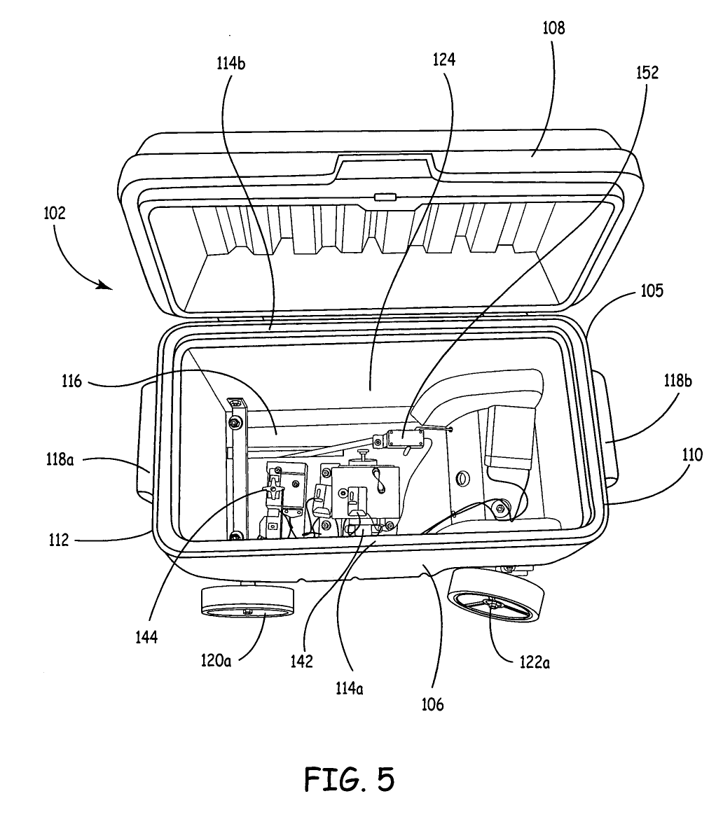

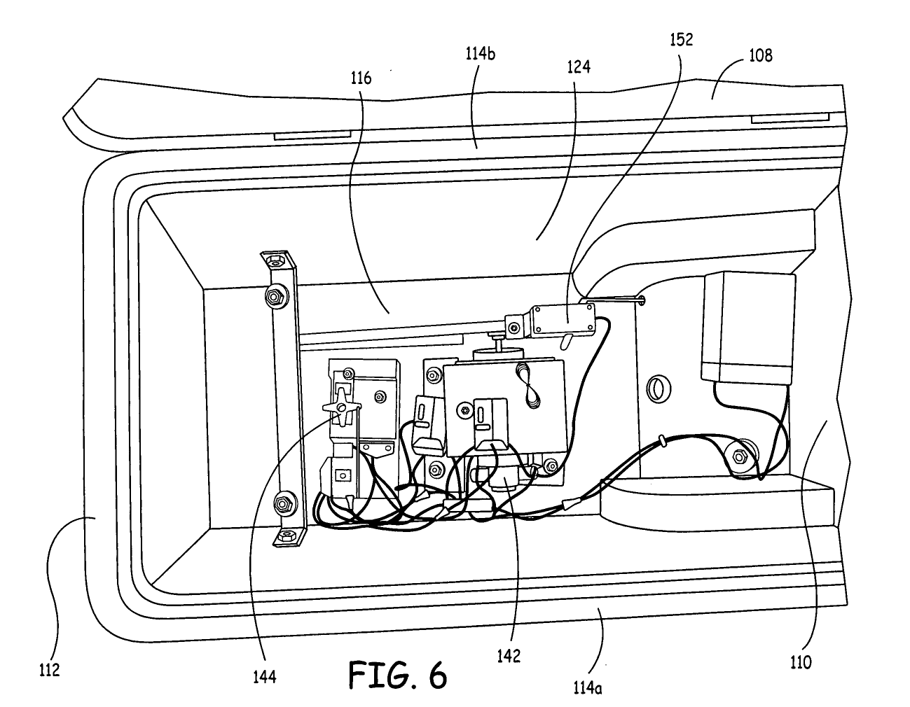

As shown in FIGS. 5 and 6, ice chest assembly 102 includes a drive assembly 136, a steering assembly 138, a power source 140 and a receiver 141 mounted within the component mounting space 128. Drive assembly 136 comprises a first motor 142, a second motor 144, an electrical switch 146, a pair of timing belt pulleys 148a, 148b and a timing belt 150. Preferably, first motor 142 is a rotational DC gear motor while second motor 144 is a rotational servomotor. In an alternative configuration, drive assembly 136 can be configured as a direct drive gear system. Steering assembly 138 comprises a third motor 152 and a linkage assembly 154. Preferably, third motor 152 is a rotational servomotor. As depicted, power source 140 comprises a battery 156 wired to power both the drive assembly 136 and steering assembly 138. Power source 140 also includes an on/off switch to cut power from the battery 156 to the other components. Preferably, battery 156 comprises a DC rechargeable battery. In alternative arrangements, power source 140 can comprise other power options, either alone or in combination with a battery system, such as solar powered, fuel cells and internal combustion engines. For example, an internal combustion engine can separately power the drive assembly 136 while a battery system powers the steering assembly 138. Receiver 141 most typically takes the form of a wireless receiver, for example a two-channel radio frequency receiver. Receiver 141 is capable of converting a digital input signal from control device 104 to a proportional signal for controlling the second motor 144 and the third motor 152.

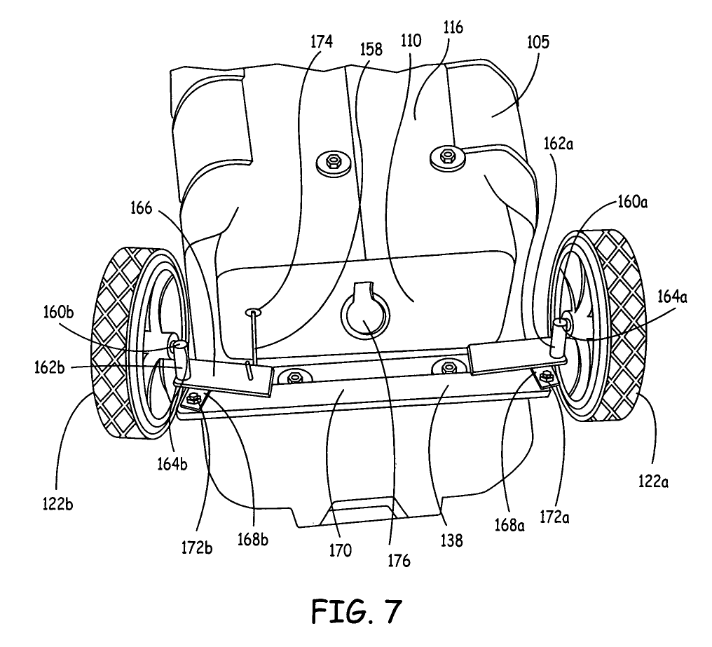

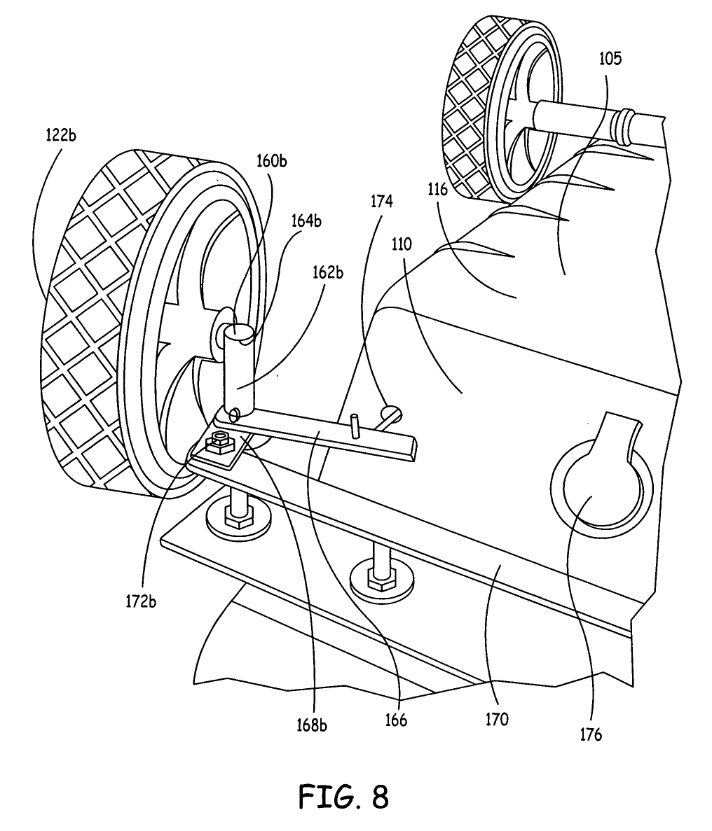

Steering assembly 138 is more clearly depicted in FIGS. 7 and 8. Steering assembly 138 comprises a connecting arm 158 operably connecting the third motor 152 and one of the steering wheels 122b. As depicted, each steering wheel 122a, 122b is mounted on its own axle 160a, 160b which is correspondingly mounted within an axle sleeve 162a, 162b, each including a bearing 164a, 164b. Axle sleeve 162b is fixedly attached to a steering arm 166. Axle sleeves 162a, 162b are also fixedly attached to a pair of linking arms 168a, 168b. Linking arms 168a, 168b are connected with a connecting rod 170 with a pair of connecting pins 172a, 172b. Connecting arm 158 projects through a steering aperture 174 in the front wall 110 of ice chest 105. As depicted, a drain plug 176 is also shown in front wall 110.

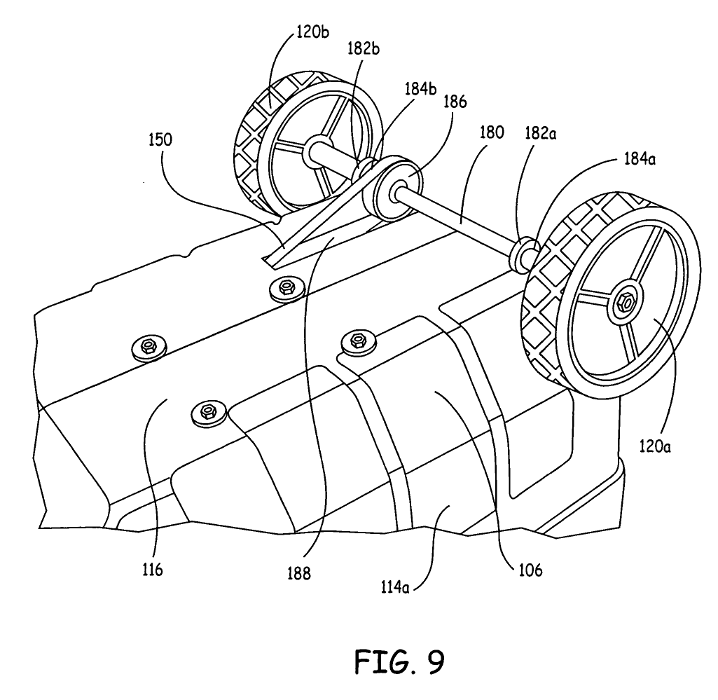

As depicted in FIG. 9, drive assembly 136 comprises a drive axle 180, a pair of axle mounts 182a, 182b including a pair of axle bearings 184a, 184b and a drive pulley 186. Timing belt 150 extends through a drive slot 188 in bottom surface 116 and wraps around drive pulley 186 such that drive assembly 136 and first motor 142 are operably connected. Drive assembly 136 may include a spring suspension for mounting drive axle 180 to reduce the effects of uneven ground.

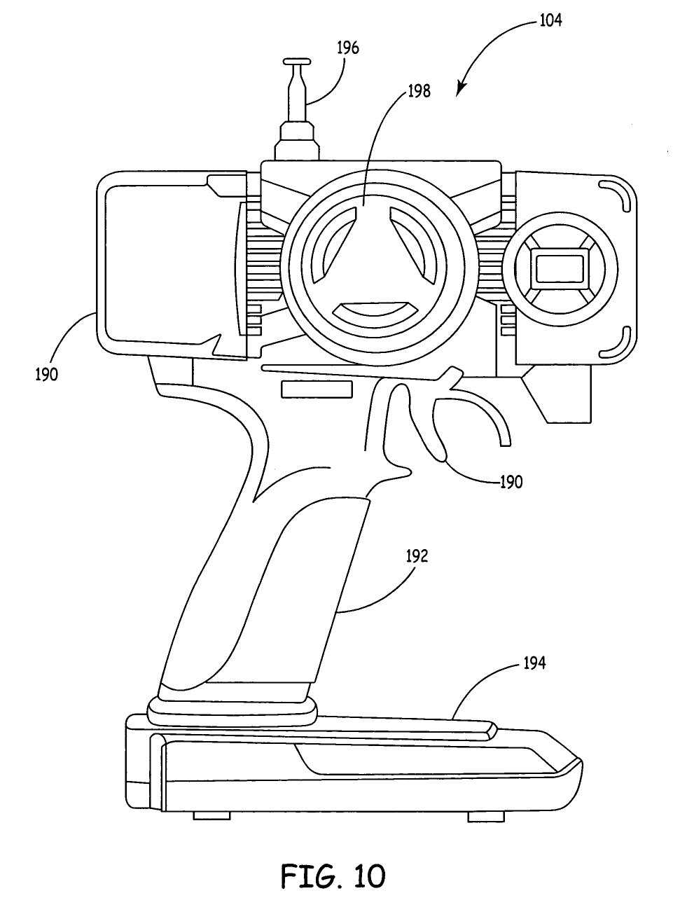

An embodiment of control device 104 is illustrated in FIG. 10. Control device 104 includes controller body 190 including a hand grip 192 and a battery storage compartment 194. Control device 104 further comprises an antenna 196, a remote wheel 198 and a throttle lever 200. Most preferably, control device 104 transmits digital proportional signals over the two channels via a wireless protocol such as radio frequency or infrared. An example of a suitable control device 104 includes those manufactured by the Futaba® Company. For example, the Futaba® Models 2PH & 2PHKA controllers are two-channel radio frequency controllers that are envisioned for use with the self-propelled, remote-controlled utility cart 100 of the present invention. Alternatively, a control device 184 including a length of control wire 85 similar to that illustrated in FIG. 1 could be used to communicate directly with the drive assembly 136 and the steering assembly 138.

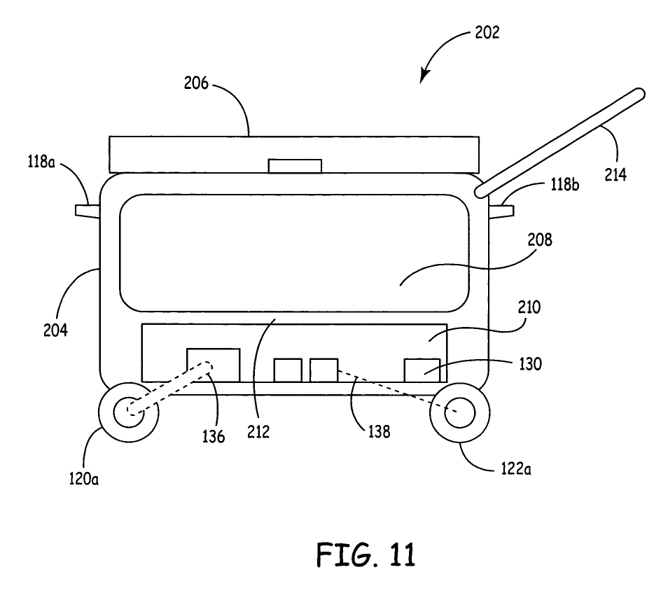

An alternative embodiment of an ice chest assembly 202 is depicted in FIG. 11. Ice chest assembly 202 is comprised of an insulated body 204 and an insulated cover 206. Insulated cover 206 can be hingedly attached or include means for slidably inserting into the insulated body 204. As depicted, insulated body 204 includes an insulated storage space 208 and a separate and distinct mounting space 210. Preferably, insulated body 204 is integrally molded such that a storage floor/mounting roof 212 prevents any possibility of leaking, such as water from melting ice, from the insulated storage space 208 into the mounting space 210. Using mounting space 210, drive assembly 136, steering assembly 138 and power source 140 are wired and mounted to insulated body 204. Insulated body 204 further includes a manual handle 214 allowing a user to pull the ice chest assembly 140 in appropriate situations.

In actual use, the self-propelled, remote-controlled utility cart 100 is most typically loaded with a combination of ice and food and/or beverages. With respect to ice chest assembly 102, a user must first sealingly install sealing floor 130 within interior storage space 124 to prevent potential water damage to components comprising the drive assembly 136, the steering assembly 138, power source 140 and receiver 141.

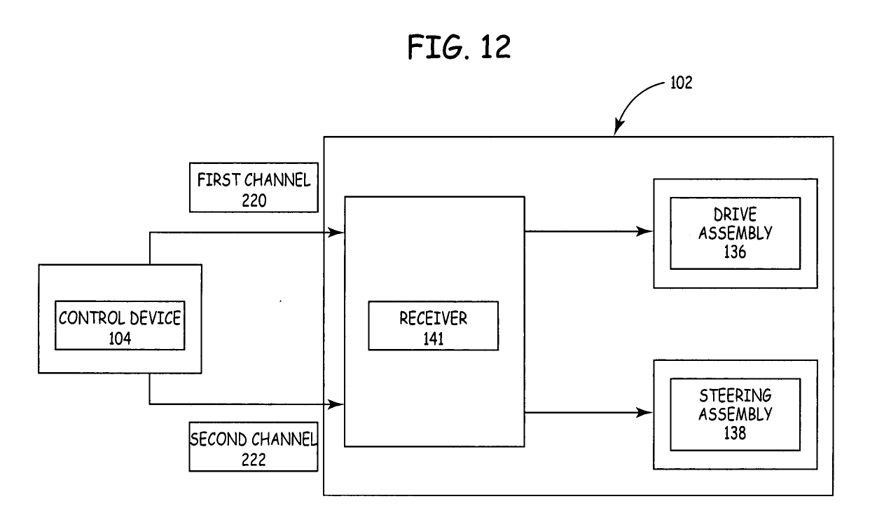

Once the self-propelled remote-controlled utility cart 100 has been loaded, a user can remotely direct the utility cart 100 through manipulation of the control device 104. As illustrated in FIG. 12, control device 104 comprises a remote control unit having at least two separate controls channels, for instance first channel 220 and second channel 222. First channel 220 and second channel 222 are used to provide radio frequency communication between the control device 104 and the receiver 141 within the ice chest assembly 102. Control device 104 typically operates at a radio frequency range of 27 MHz, 50 MHz, 72 MHz or 75 MHz. For a control device 104 operating at 75 MHz, first channel 200 could correspond to 75.410 MHz while second channel 222 could correspond to 75.430 MHz. In the present invention, first channel 220 is used to communicate user inputs from the throttle lever 200 to the second motor 144 of the drive assembly 136 while the second channel 222 is used to communicate user inputs from the remote wheel 198 to the third motor 152 of the steering assembly 138. Alternatively, control device 104 can transmit control signals via alternative wireless protocols such as an infrared signal.

With respect to drive assembly 136, a user depresses throttle lever 200 causing a digital signal to be transmitted to receiver 141 over first channel 220. Receiver 141 converts the digital signal to a proportional signal which subsequently controls the second motor 144. Second motor 144 is linked to a speed controller such that when the second motor 144 turns in one direction, positive DC voltage is applied to the first motor 142 and when the second motor 144 turns in the opposition direction, negative DC voltage is applied to the first motor 142. Timing belt 150 is coupled to the first motor 142 at one end and to the drive pulley 186 at the other end. As motor 142 causes timing belt 150 to turn, drive pulley 186 is forced to rotate such that drive axle 180 turns and drive wheels 120a, 120b cause ice chest assembly 102 to be propelled forward or backward depending upon the DC voltage applied to the first motor 142.

With respect to steering assembly 138, a user turns the remote wheel 198 causing a digital signal to be transmitted to receiver 141 over second channel 222. Receiver 141 converts the digital signal to a proportional signal which subsequently controls the third motor 152. Third motor 152 is linked to the connecting arm 158 such that when the second motor 144 turns, connecting arm 158 causes steering arm 166 to move in a left or right direction. As steering arm 166 moves, the steering wheels 122a, 122b are directed in the desired direction through the interconnection of the linking arms 168a, 168b and the connecting rod 170. Through the combination of the drive assembly 136, steering assembly 138 and control device 104, a user can remotely direct the movement of the self-propelled, remote-controlled utility cart 100 as desired.

Although various embodiments of the present invention have been disclosed here for purposes of illustration, it should be understood that a variety of changes, modifications and substitutions may be incorporated without departing from either the spirit or scope of the present invention.

1. A remote-controlled, self-propelled utility cart for carrying domestic items comprising:
a load carrying body configured to carry a household item, wherein said load carrying body has a manual handle and is supported by a plurality of wheels;
a drive assembly, wherein said drive assembly drives at least one of said plurality of wheels;
a steering assembly, wherein said steering assembly steers at least one of said plurality of wheels;
a receiver, wherein said receiver is positioned proximate said load carrying body and is in communication with said drive assembly and said steering assembly; and
a remote controller, wherein said remote controller remotely communicates with said receiver to convey a desired speed and direction of said drive assembly and a desired turn orientation of said steering assembly, wherein said receiver receives the desired conveyances and communicates the desired conveyances to said drive assembly and said steering assembly, respectively.

2. The utility cart of claim 1, wherein the remote communication is via a wireless communications protocol or through a control wire operably connecting the remote controller and the receiver.

3. The utility cart of claim 2, wherein the wireless communications protocol is selected from the group consisting essentially of: radio frequency control and infrared control.

4. The utility cart of claim 1, wherein said load carrying body comprises a thermal cooler box.

5. The utility cart of claim 1, wherein at least a portion of said drive assembly is maintained within the confines of said load carrying body.

6. The utility cart of claim 5, wherein said receiver is mounted to said load carrying body.

7. The utility cart of claim 6, wherein at least a portion of said steering assembly is maintained within the confines of said load carrying body.

8. The utility cart of claim 7, wherein said portion of said drive assembly and said steering assembly maintained within the confines of said load carrying body are separated from said household items by a loading floor.

9. The utility cart of claim 8, wherein said load carrying body includes a mounting floor, wherein said portions of said drive assembly and said steering assembly that are maintained within said load carrying body are mounted on said mounting floor.

10. The utility cart of claim 1, wherein said desired direction is selectable from the group consisting of: a straight line and an arc.

11. A remote-controlled, self-propelled utility cart for carrying a load comprising:
support means for supporting and carrying said load, the support means having a manual handle;
thrust means for moving said support means in a forward and backward direction of travel;
signal receiving means for receiving remotely generated signals and for supplying them to said thrust means; and
a control means for remotely generating a signal to designate said forward and backward direction of said thrust means, for remotely generating a signal to designate a speed of said thrust means, and for transmitting said remotely generated signals to said signal receiving means.

12. The utility cart of claim 11, wherein said remotely generated signals comprise a wireless protocol selected from the group consisting essentially of: radio frequency signals and infrared signals.

13. The utility cart of claim 11, wherein said support means comprises a thermal cooler box.

14. The utility cart of claim 13, wherein a least a portion of said thrust means is maintained within the confines of said thermal cooler box.

15. The utility cart of claim 14, wherein said thermal cooler box comprises a selectively removable loading floor defining a loading portion and a mounting portion.

16. The utility cart of claim 14, wherein said thermal cooler box comprises a molded loading floor defining a loading portion and a mounting portion.

17. The utility cart of claim 11, wherein said forward and backward direction is along a line of travel selected from the group consisting of: a straight line and an arced line.

18. The utility cart of claim 11, wherein said thrust means comprises a power source, a steering assembly operably connected to a steering wheel assembly and a drive assembly operably connected to a drive wheel assembly, wherein said power source selectively powers said steering assembly and said drive assembly.

19. A self-propelled, remote-controlled ice chest comprising:
an ice chest comprising an insulated body and a cover, the insulated body including a steering assembly, a drive assembly, a power source and a mounting space that is sealingly separated from a storage space, the power source adapted to selectively power the drive assembly and the steering assembly, the drive assembly adapted to interface with a drive wheel assembly while the steering assembly is adapted to interface with a steering wheel assembly;
a receiver proximate the ice chest; and
a remote controller, the controller including a transmitter operating at a frequency receivable by the receiver, the controller further comprising a throttle control and a steering control, the controller communicating with the receiver to direct movement of the ice chest.

20. The self-propelled, remote-controlled ice chest of claim 19, wherein the insulated body includes a perimeter bracket, the perimeter bracket adapted to accommodate an insulated sealing floor to sealingly separate the storage space and the mounting space.

21. The self-propelled, remote-controlled ice chest of claim 19, wherein the insulated body is integrally molded such that the storage space and the mounting space are separated by a molded, wall member.

22. The self-propelled, remote-controlled ice chest of claim 19, wherein the power source is selected from the group consisting of: internal combustion engine, fuel cell and batteries.

23. The self-propelled, remote-controlled ice chest of claim 19, wherein the remote controller comprises at least a two-channel controller, a first channel for controlling operation of the drive assembly and a second channel for controlling operation of the steering assembly.
